(19) United States
(12) Patent Application Publication
(10) Pub. No.: US 2026/0077471 A1
(43) Pub. Date: Mar. 19, 2026

(54) HAND-HELD POWER TOOL AND BATTERY FOR POWER TOOL

(71) Applicant: Hubbell Incorporated, Shelton, CT (US)

(72) Inventors: Brian McCulloh White, Manchester, NH (US); John David Lefavour, Litchfield, NH (US); David Compton Heck, Amherst, NH (US); Jason Alan Breitenbach, Rolla, MO (US)

(21) Appl. No.: 19/120,341

(22) PCT Filed: Oct. 24, 2023
(86) PCT No.: PCT/US2023/077617

§ 371 Date: Apr. 11, 2025

Related U.S. Application Data
(60) Provisional application No. 63/419,407, filed on Oct. 26, 2022.

(51) Int. Cl. B25F 5/00; H01M 4/62; H01M 10/0525; H01M 10/42; H01M 50/247; H01M 50/51; H01R 43/042

(52) U.S. Cl. CPC B25F 5/005; H01M 4/625; H01M 10/0525; H01M 10/4264; H01M 50/247; H01M 50/51; H01M 2220/30; H01R 43/0428

(57) ABSTRACT

A hand-held battery powered hydraulic tool includes a tool frame having a motor, a working head operatively coupled to the tool frame and selectively actuatable by the motor and a rechargeable battery pack configured to power the motor, the battery pack is removably connected to the tool frame. The battery pack includes one or more cells. The cell includes first and second electrodes and an electrolyte. One or both of the first and second electrodes include a support layer and an electrochemically reactive species on the support layer and in contact with the electrolyte, and wherein the support layer includes a high specific surface area material.

### CROSS-REFERENCE TO RELATED APPLICATION

This application claims priority to U.S. Provisional Application Ser. No. 63/419,407 filed Oct. 26, 2022 entitled HAND-HELD POWER TOOL AND BATTERY FOR POWER TOOL the contents of which are incorporated herein in their entirety by reference.

### BACKGROUND

### Field

The present disclosure relates to handheld battery powered tools and, more particularly, to battery packs that are used to power handheld battery powered tools.

### Description of the Related Art

Portable, handheld battery powered tools are used to perform a variety of tasks including drilling, fastener driving, sawing, grinding, crimping, and so on. Such tools include a power source such as a battery, an electric motor, and a working component driven by the electric motor, such as a drill head, crimper, and the like. Such tools are powered by a rechargeable battery, which in many instances for handheld power tools on the market today is a lithium-ion (Li-ion) based rechargeable battery.

While Li-ion rechargeable battery cells are an improvement over the last generation of rechargeable batteries, they still suffer from several disadvantages. Li-ion based rechargeable batteries may require protection from being overcharged. Overcharging may damage the battery cells and can potentially cause runaway heating leading to fires. Li-ion cells may also need to be protected from overly rapid discharge. Current drawn from the cells may lead to melting of internal components, leading to battery failure. Even during normal operation, excess heat generated during rapid charging and discharging may also reduce the useful life of the battery pack.

Li-ion cells use a flow of ions through an organic solvent electrolyte to charge and discharge. Heating caused by rapid charging and discharging can vaporize this solvent, creating a flammable gas that can ignite, possibly resulting in fire or explosion. This problem may be of particular concern in the field of power tools. To develop sufficient force to perform some tasks may require a battery cell to deliver large amounts of current for brief periods of time. Modern Li-ion batteries typically include a power management system that limits current into and from the battery to avoid overheating the Li-ion cells. These limitations may reduce the range of tasks a tool can perform or may require larger or more numerous battery cells to accomplish particular tasks. This may increase the size and weight of the tool. Reducing the current flowing through the battery pack during charging increases the time required to recharge, potentially limiting the usefulness of the battery pack.

Li-ion based rechargeable batteries may also have a memory effect. Repeated charge and discharge cycles may reduce the capacity of electrodes to absorb and desorb electrochemical species. This effect may cause known Li-ion cells to degrade and become unusable over time.

Known Li-ion based rechargeable batteries are relatively heavy and bulky in size. Additionally, the shipment and disposal of Li-ion rechargeable batteries have been further complicated by the recent updates to the Hazardous Materials Regulations by the U.S. Department of Transportation. These regulations limit how and where devices, including power tools that use Li-ion cells can be stored and transported.

Typical Li-ion cells have a carbon/metal oxide cathode. Most commercial Li-ion cells use an oxide of cobalt, for example LiCoO₂ and graphite to form the cathode. Mining and processing of cobalt may have negative environmental consequences. Moreover, cobalt is relatively expensive, increasing the cost for tools using Li-ion batteries.

Li-ion cells typically have a graphite anode that is impregnated with lithium metal atoms dispersed within the crystal structure and/or pores of the graphite. This anode is separated from the graphite/cobalt oxide cathode by a porous polymer membrane that insulates the anode and cathode from one another. A lithium salt (typically a fluoride or phosphide salt) dissolved in an organic solvent forms the electrolyte. The anode and cathode are immersed in the electrolyte. When the cell is discharged, for example, to power a tool, lithium atoms adsorbed on the anode are oxidized, generating positively charged lithium ions and liberating electrons to create current to drive an external load such as the tool. The positively charged lithium ions dissolve in the electrolyte and diffuse through the membrane and migrate to the cathode, where they react with the cobalt oxide and electrons flowing from the external load to form LiCoO₂.

During charging the reactions are reversed. Positively charged lithium ions are liberated from the cathode and diffuse through the electrolyte to the anode. At the anode, these ions combine with electrons to reduce the lithium ions to neutral lithium atoms that are incorporated into the graphite anode.

The amount of current available from a Li-ion cell is determined by the rate at which reactions can occur at the anode and cathode. Graphite electrodes provide a conductive structure to hold lithium ions and metal during charge and discharge cycles. Providing a low resistance path for current increases the efficiency of the cell and reduces resistive heating of the cell. One problem with known Li-ion cells is that metal oxides forming the reactive species on the cathode generally have low conductivity. Higher resistance at the cathode creates ohmic heating during charging and discharging. Another problem with known Li-ion cells is that uneven distribution of reactive species across surfaces of the electrodes may leave some reactive species unavailable for electrochemical reactions, reducing the amount of current that can be delivered during discharge and increasing the time required to recharge the cell.

Accordingly, there is a need for a rechargeable battery that can be used in a battery pack to power portable, handheld tools, and that does not have some or all of the disadvantages of known Li-ion based rechargeable batteries described above.

### SUMMARY

The present disclosure provides embodiments of a rechargeable battery that can be used in a battery pack to power handheld and portable power tools, such as a drill, saw, grinder, crimping tool, fastener gun, and the like, that are known to be used in various industrial, residential, and/or construction applications. Although the embodiments of the rechargeable battery within the present disclosure are contemplated for use with a wide variety of handheld, portable power tools, the exemplary embodiments of the present disclosure will be described herein with reference to a hydraulic crimping tool that is typically used in industrial and/or construction applications for crimping electrical connectors.

According to an illustrative embodiment, a hand-held battery powered hydraulic tool includes a tool frame having a motor, a working head operatively coupled to the tool frame and selectively actuatable by the motor and a rechargeable battery pack configured to power the motor, the battery pack is removably connected to the tool frame. The battery pack includes one or more cells. The cell includes first and second electrodes and an electrolyte. One or both of the first and second electrodes include a support layer and an electrochemically reactive species on the support layer and in contact with the electrolyte, and wherein the support layer includes a high specific surface area material.

According to another illustrative embodiment, a battery powered crimping tool includes a tool frame having an electrical motor, a hydraulic pump mechanically connected with the motor, a piston hydraulically connected with the pump to move relative to the tool frame, wherein the piston comprises a ram, an anvil mechanically fixed to the tool frame, wherein movement of the piston drives the ram toward the anvil, wherein the ram and anvil are adapted to deform a workpiece placed between the anvil and the ram, a battery electrically connected with the motor, wherein the battery including one or more rechargeable electrochemical cells and one or more capacitive storage devices and a controller electrically connected with the cell and storage device of the battery and with the motor. At first phase of a crimp, the controller disables current from flowing from the capacitive storage device and allows current to flow from the electrochemical cell to energize the motor to cause the hydraulic pump to move the piston to contact the workpiece with both the anvil and the ram. At a second phase of a crimp, motion of the ram deforms the workpiece and the controller allows current to flow from both the capacitive storage device and the electrochemical cell to energize the motor to enable the further motion. At a third phase of the crimp, the controller detects that the crimp is completed and disables current from flowing from both the capacitive storage device and the electrochemical cell.

The hydraulic tool may include a tool frame, a working head, an impactor, a control system, a battery pack connectable to the tool frame, a motor coupled to the tool frame and adapted to be powered by the battery pack, and a hydraulic drive system coupled to the motor by a gear reduction transmission. The hydraulic drive system is operable to longitudinally move the impactor relative to the frame.

According to one embodiment, the battery pack is removably connected with the tool. The battery pack comprises a housing, a connection interface, and one or more battery cells disposed within the housing. According to one embodiment, cells comprising the battery pack use lithium-ion chemistry but include materials forming the anode and cathode that increase the performance of the battery pack. According to one embodiment, the anode, the cathode or both anode and cathode include graphene, a carbon allotrope that forms single-atom thickness sheets. According to other embodiments, instead of, or in addition to graphene, one or both of the electrodes include other carbon allotropes that form three-dimensional carbon structures, including carbon nanotubes and carbon spheres. Carbon allotropes have a high specific surface area, providing an increased number of sites for electrochemical reactions to take place. Also, the ordered structure of the surfaces of these allotropes may allow reactive species, such as metal oxides, to be more evenly distributed, forming regions were a mono-layer of the reactive species is spread across the allotrope surface. Because materials such as graphene have very high electrical and thermal conductivity, ohmic heating of the electrodes during charging and discharging may be reduced compared with graphite-based electrode.

According to another embodiment, instead of or in addition to using carbon and carbon/metal oxide materials to form the electrodes, other reactive species is used. According to one embodiment, the cathode is formed from sulfur or a compound of sulfur and the anode is formed from lithium metal. During discharge, lithium atoms are oxidized, releasing electrons to drive the tool, and generating positive ions that migrate through an electrolyte to the cathode. The lithium ions reduce the charge state of sulfur atoms of the cathode, forming lithium-sulfur compounds. Because sulfur and lithium are light elements, cells based on lithium-sulfur technology can achieve a high energy density, reducing the weight of the battery pack.

According to another embodiment, instead of lithium, other metals can be used as the basis for energy storage in the cells. According to one embodiment, cells rely on aluminum ion chemistry to store electrical energy.

According to another embodiment, instead of using lithium chemistry, cells forming the battery pack use nickel-hydrogen chemistry. A nickel hydroxide material forms the anode and hydrogen gas in contact with a catalyst, such as platinum, forms the cathode. A hydroxide solution, such as potassium hydroxide forms a liquid electrolyte. Cells based on nickel-hydrogen chemistry can withstand many charge-recharge cycles with very little loss in storage capacity. Battery packs comprising such cell have a long service life, potentially increasing the lifetime of the battery pack and reducing costs over the lifetime of the hydraulic tool.

According to a further embodiment, the cells include a capacitive storage device, such as an ultracapacitor. Rather than relying on chemical reactions to store and discharge electrical energy, ultracapacitors store electrical charge on interleaved sheets of conductors separated by dielectric layers. Ultracapacitors may include a liquid or semiliquid electrolyte disposed between the electrodes. Compounds dissolved in the electrolyte align with the electric field produced by charges on the electrodes, further increasing the capacitance of the device and increasing the amount of energy stored. Because ultracapacitors do not require chemical reactions to charge and discharge, they are not limited by the rate of chemical reactions at the electrodes, can charge and discharge very rapidly, and can therefore deliver large amounts of current for brief periods of time. Ultracapacitors can withstand many charge/discharge cycles, potentially increasing the lifetime and reliability of the battery pack.

According to a further embodiment, a power tool includes a battery pack formed by a plurality of electrically connected cells that store electrical energy, as discussed above, and a controller that monitors conditions of the cells, and of the battery pack. According to one embodiment, the controller modulates the current flowing into and out from the cells to maintain the parameters of the cells within a selected operating range. According to a further embodiment, the controller monitors the temperatures of each of the cells and modulates operation of the tool and/or the battery pack to assure safe operation of the battery pack.

As compared with battery pack using only known lithium-ion cells, the cells in the battery pack according to the disclosure may provide increased storage capacity, lower internal resistance, improved heat dissipation, wider operating temperature range, lower self-heating during charge and discharge, smaller size, lighter weight, increased lifetime, increase cycle lifetime, longer idle storage lifetime, and the like.

According to one embodiment, there is provided a tool, including a battery pack. The battery pack includes one or more cells connected with electrodes to deliver current from the cells to the tool. One or more of the cells include a graphite allotrope material forming at least a part of the cathode, wherein a selected functionalizing moiety, such as a metal oxide, is disposed on the surface of the allotrope material. The allotrope may be one or more of graphene sheets, carbon nanotubes, carbon balls, carbon fiber-cloth, carbide-derived carbon, and/or a carbon aerogel. The functionalizing moiety may be an oxide of one or more of lithium, potassium, sodium, magnesium, cobalt, and aluminum. According to another embodiment, the moiety is an oxide of vanadium.

According to one embodiment, the oxide forms a monolayer on all or a part of the surface of the graphite allotrope. Bonding the metal oxide in a monolayer provides an extensive surface area to which ions can react during charging and discharging, increasing the maximum rate of electrochemical reactions. This increased rate of reaction may provide increased current to the tool when a large current is required, for example, when forming a crimp.

According to an embodiment of the present disclosure a battery for powering a hand tool includes one or more rechargeable electrochemical cells, one or more capacitive storage devices and a controller electrically connected with the cell and storage device and the tool. At a first phase of operation of the tool, the controller disables current from flowing from the capacitive storage device and allows current to flow from the electrochemical cell to energize the tool. At a second phase of operation of the tool, the controller allows current to flow from both the capacitive storage device and the electrochemical cell to energize the tool, and at a third phase of operation of the tool, the controller disables current from flowing from both the capacitive storage device and the electrochemical cell.

According to one embodiment, a tool according to the present disclosure comprises a motor and gear reduction transmission are operable to drive the hydraulic drive system to longitudinally move the impactor by more than 1.3 inches relative to the frame in less than 25 seconds and can produce at least about 6,000 psi pressure in the hydraulic drive system.

According to one form of the present invention, the battery pack delivers sufficient current to drive the mechanism of the tool to create a number of crimps before requiring recharging.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 is a front perspective view of a battery operated hydraulic electrical connector crimping tool, in accordance with the present invention;

FIG. 2 is a schematic block diagram of electrical and mechanical components of the hydraulic tool of FIG. 1;

FIG. 3 is a side elevation view of a working head of the hydraulic tool of FIG. 1 and a portion of a main body of a tool frame of the hydraulic tool of FIG. 1, illustrating a piston of the hydraulic tool in a home position;

FIG. 4 is a side elevation view of the working head and the portion of the main body of the tool frame shown in FIG. 1, with the piston of the hydraulic tool shown in an actuated position;

FIG. 5A is a front perspective view of a battery pack for use with the hydraulic tool of FIG. 1;

FIG. 5B is a detailed perspective view of a portion of the tool of FIG. 1 adapted to interface with the battery pack of FIG. 5A;

FIG. 6 is a detailed view of a hydraulic pump mechanism forming a component of the tool of FIG. 1;

FIG. 7 is a graph showing current provided by a battery pack to a hydraulic electrical connector crimping tool according to embodiments of the disclosure as a function of displacement of a working head of the tool while performing a crimp operation;

FIG. 8 is a schematic block diagram of an electrical circuit interconnecting components of a battery pack according to embodiments of the disclosure;

FIG. 9 is a detailed view of a portion of an electrical storage cell according to embodiments of the disclosure;

FIG. 10 is perspective view of a two-dimensional hexagonal lattice of atoms forming a sheet of graphene;

FIG. 11 shows perspective views of various shapes and forms of graphene structures that may be formed from the lattice shown in FIG. 10;

FIG. 12 is a perspective view of a portion of an electrical storage cell according to another embodiment of the disclosure; and

FIG. 13 is a flow chart illustrating operation of a battery pack according to embodiments of the disclosure.

### DETAILED DESCRIPTION

While illustrative embodiments of the present disclosure will be described and illustrated herein, it should be understood that these are exemplary of the disclosure and are not to be considered as limiting. For example, although embodiments of a battery pack disclosed herein are made with reference to a hydraulic crimping tool, it will be understood that the embodiments of the battery pack of the present disclosure are equally applicable and can be used for a variety of handheld, portable power tools, such as a drill, saw, grinder, fastener gun, and the like. Thus, additions, deletions, substitutions, and other modifications can be made without departing from the spirit or scope of the present disclosure. Accordingly, the present disclosure is not to be considered as limited by the foregoing description.

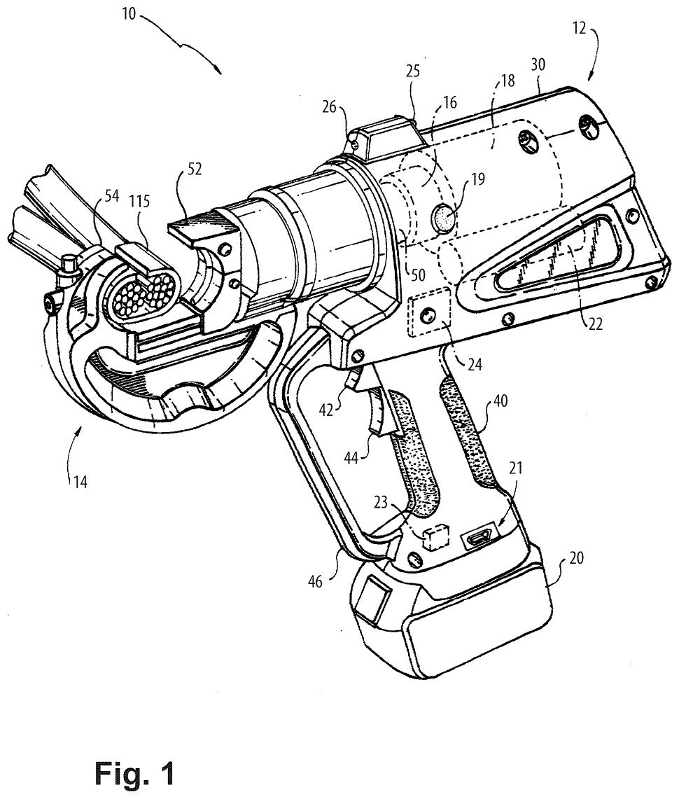

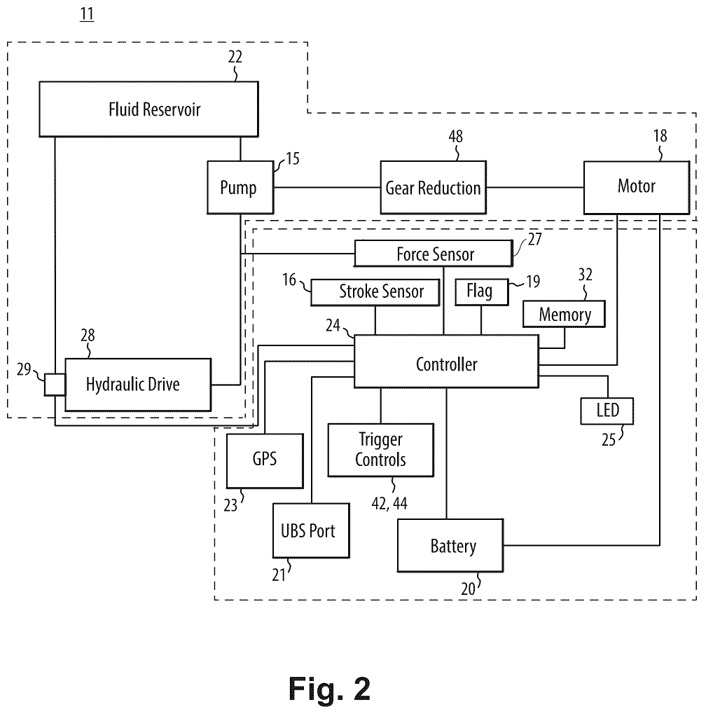

Referring now to the drawings and the illustrative embodiments depicted therein, a hydraulic tool 10 for forming crimps and other electrical connections, as shown in FIG. 1, includes a frame 12 and a working head 14. The tool frame 12 includes a main body 30 and a handle 40 that form a pistol-like shape. However, the tool frame 12 could be in any suitable type of shape. Within the main body 30 of the tool frame 12 is a battery driven hydraulic and control system 11, illustrated schematically in FIG. 2. In the illustrated embodiment of FIG. 2, the hydraulic system includes a motor 18, a gear reduction box 48, a pump 15, a hydraulic fluid reservoir 22, a hydraulic drive 28 and a relief valve 29. The control system includes a battery pack 20, a controller 24, a memory 32, one or more operator controls 42 and 44, a communication port 21, a location system 23, a stroke sensor 16, a force sensor 27, a flag switch 19, and a status indicator 25.

The battery pack 20 provides power to the controller 24. The battery pack 20 also provides power to the motor 18 under the control of controller 24 and the operator controls 42 and 44. The motor 18 drives the pump 15 via gear reduction box 48. The pump 15 is in fluid communication with the hydraulic fluid reservoir 22. When driven by the motor 18, the pump 15 delivers fluid under pressure from reservoir 22 to the hydraulic drive 28. Force generated by hydraulic drive 28 is delivered via a piston to the working head 14 (FIG. 1), as described below. The force sensor 27 is provided to measure the force applied to a workpiece as described below. Non-limiting examples of the force sensor 27 include pressure sensors or transducers, load cells, strain gauges and other force measuring devices. It is contemplated that the force sensor 27 is a pressure sensor. According to one embodiment force sensor 27 is connected to the hydraulic drive 28 and senses the hydraulic pressure in the hydraulic drive 28. The controller 24 receives data indicating the pressure in the hydraulic drive 28 from sensor 27 and determines (or computes) a force applied by the tool 10 on the workpiece. The controller 24 receives signals from the one or more operator controls 42, 44 to activate and deactivate the motor 18 which activates and deactivates the hydraulic drive 28, respectfully.

Relief valve 29 connects the hydraulic drive 28 with the fluid reservoir 22. According to an embodiment, the relief valve 29 is a mechanically actuated valve designed to open when a predetermined maximum pressure is reached in the hydraulic system. When the relief valve 29 is opened, fluid flows from the hydraulic drive 28 back to reservoir 22 relieving pressure in hydraulic drive 28 and removing the force applied on the workpiece by the piston 60. A spring (not shown) may be provided as part of hydraulic drive 28 to return the piston 60 to a home position when pressure in hydraulic drive 28 is relieved. It is noted that when the relief valve 29 opens, the relief valve may make an audible indication, such as a “pop” like sound, that the relief valve 29 has opened.

The controller 24 monitors the pressure in hydraulic drive 28 to determine when a crimp cycle is complete. After actuating the motor 18 in response to activation of an operator control, e.g., trigger switch 44, the controller 24 monitors the hydraulic fluid pressure in the hydraulic system via the force sensor 27. When the relief valve 29 opens and the pressure in the hydraulic system drops below a predetermined minimum threshold, the controller 24 determines that a crimp cycle is complete. As shown in FIG. 1, an indicator light 25 is positioned on a top portion of the main body 30 of the tool frame 12 facing in the proximal direction so that it is visible to the tool user. The indicator light 25 is electrically connected to the controller 24. According to one embodiment, the light 25 is a bi-color LED that can be energized to illuminate in two distinct colors, such as red and green. However, other types of LED indicators may be used, such as a tri-colored LED capable of emitting red, green and yellow light. When the controller 24 determines that the crimp cycle is complete and that the hydraulic system has reached a predetermined threshold pressure, the controller 24 energizes light 25 to illuminate green to indicate a successful crimp. If the hydraulic system was not able to reach the predetermined threshold pressure during the crimp cycle, because, for example, there was insufficient battery power to reach the desired threshold pressure or because the pressure setting of the relief valve 29 is out of calibration, the controller 24 energizes the light 25 to illuminate red. It is noted that the present disclosure also contemplates that the controller 24 may activate a sound generating device (not shown) when the controller 24 determines that the crimp cycle is complete, and that the hydraulic system has reached a predetermined threshold pressure to indicate a successful crimp.

The controller 24 may be a microprocessor, microcontroller, application specific integrated circuit, field programable gate array (FPGA) or other digital processing apparatus as will be appreciated by those skilled in the relevant art. The controller 24 communicates with memory 32 to receive program instructions and to retrieve data. Memory 32 may be read-only memory (ROM), random access memory (RAM), flash memory, and/or other types of electronic storage known to those of skill in the art. The controller 24 is configured to communicate with external computing devices or networks via a communication port 21, seen in FIG. 1. The communication port 21 may be a physical connection, such as a USB port, a wireless communication interface, such as WiFi, Bluetooth, and the like, a removeable memory device, such as a SIM card or flash drive, or combinations thereof. Non-limiting examples of external networks include Wireless Local Area Networks (WLAN). Non-limiting examples of external computing devices include desktop and laptop computers, tablets, smart phones, and devices that manage networks, such as devices that manage a WLAN and is connected to multiple Communication ports 21 on different tools simultaneously. The external computing devices may also regularly monitor diagnostic information on the tool 10 and location information of the tool 10 and can upload this tool information to the web services 210. According to some embodiments, controller 24 communicates with circuitry with the housing of battery 20 to monitor and control the flow of current into and out from the battery, as will be described more fully below.

Returning to FIG. 1, the handle 40 also supports the one or more operator controls, such as the trigger switches 42 and 44, which can be manually activated by a tool user. The handle 40 may include a hand guard 46 to protect a tool user's hand while operating the tool 10 and to prevent unintended operation of trigger switches 42 and 44. According to an embodiment of the present disclosure, one of the operator controls (e.g., trigger switch 44) may be used to activate the hydraulic and control system 11 while the other operator control (e.g., trigger switch 42) may be used to cause the hydraulic and control system 11 to deactivate so that the hydraulic drive 28 is depressurized.

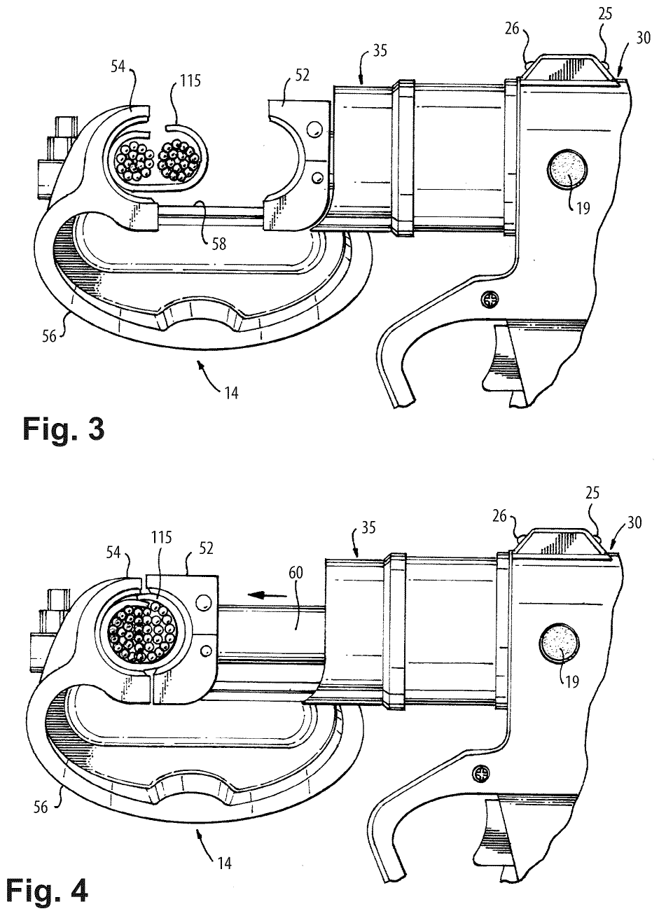

Referring now to FIGS. 1, 3 and 4, the working head 14 includes an impactor 52, and anvil 54. The impactor 52 is configured to move between a home position, shown in FIG. 3, and an actuated or crimping position, shown in FIG. 4. The impactor 52 is configured and dimensioned to connect to or couple with the piston 60 of the hydraulic system within the main body 30 of the tool frame 12. As described above, in an exemplary embodiment, one of the trigger switches (e.g., trigger switch 44) may be used to activate the hydraulic and control system 11 by activating the motor 18 that causes the hydraulic pump 15 to activate via the gear reduction box 48, which pressurizes the hydraulic drive 28 to drive the piston 60 in the distal direction, as shown by the arrow in FIG. 4. Driving the piston 60 distally causes the impactor 52 to move to the crimping position and deliver force to the workpiece. The other trigger switch (e.g., trigger switch 42) may be used to cause the hydraulic and control system 11 to deactivate so that the hydraulic drive 28 is depressurized causing the piston 60 to retract in the proximal direction to the home position, shown in FIG. 3. As noted above, a spring (not shown) may be provided as part of hydraulic drive 28 to return the piston 60 to the home position when pressure in hydraulic drive 28 is relieved. The impactor 52 is operatively coupled to the guide 58 on the arm 56 of the working head 14 so that the impactor 52 can move along the guide 58 as the piston 60 moves the impactor between the home and crimping positions. For example, when the piston 60 is driven in the distal direction, the piston moves the impactor 52 along the guide 58 from the home position, seen in FIG. 3, toward the crimping position, as shown in FIG. 4.

The arm 56 has at its proximal end a ring 35 used to connect the working head 14 to the tool frame 12, as is known. In the illustrated embodiments of FIGS. 3 and 4, the working head 14 and the frame 12 are permanently joined with one another via the ring 35, though they may be configured to be removably connected. The ring 35 has a center aperture (not shown) through which the piston 60 passes in order to connect to the impactor 52. The distal end of the arm 56 includes or forms the anvil 54. When a workpiece 115 is placed in the working head 14 between the impactor 52 and the anvil 54 and motor 18 of the tool 10 is activated, piston 60 is driven from the home position toward the crimping position. As the impactor 52 moves toward the anvil 54, the workpiece may also move toward the anvil. When the impactor 52 and anvil 54 both contact the workpiece, further movement of the impactor 52 causes the impactor and anvil 54 to deform the workpiece thus making the crimp. It thus should be understood that the home position is when the impactor 52 is adjacent the ring 35, and the crimping position is when the impactor 52 and anvil 54 deform the workpiece. In the example shown in FIGS. 3 and 4, two conductors surrounded by a deformable crimp connector form workpiece 115.

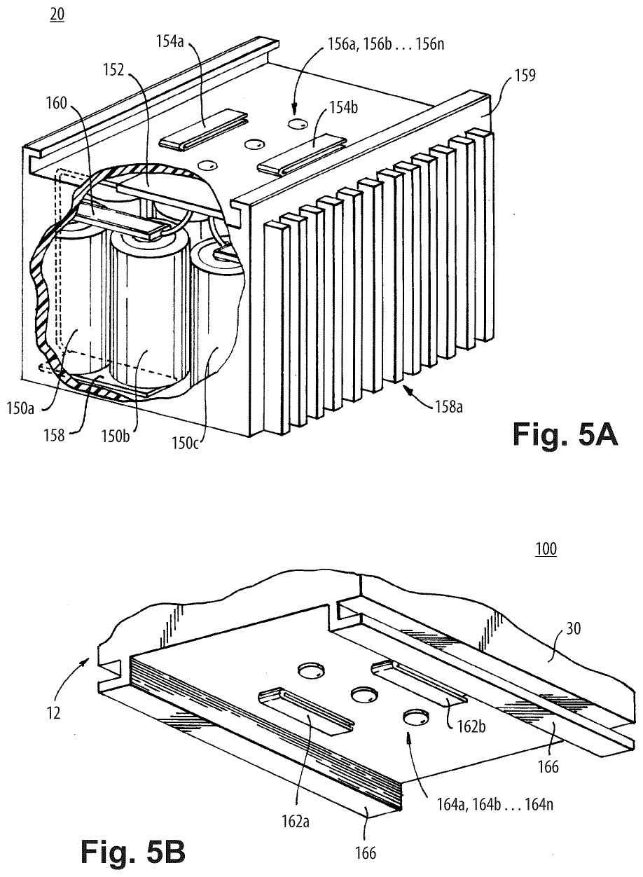

FIG. 5A shows a detailed view of battery pack 20 and FIG. 5B shows a detail of a connecting portion 100 of main body 30 adapted to releasably couple with battery 20 according to an embodiment of the disclosure. Battery pack 20 can be removed and recharged separately from the tool using, for example, a battery charger, as will be described below. Power electrodes 154a, 154b on battery pack 20 connect the battery pack 20 with the motor 18, controller 24 and other electrically driven components of the tool via power contacts 162a and 162b on connecting portion 100 of main body 30. Power electrodes 154a, 154b and/or power contacts 162a, 162b may be leaf springs shaped to resiliently contact one another to provide a low resistance electrical connection. One or more control electrodes 156a, b, . . . n on battery 20 are provided to connect with corresponding electrodes 164a, b, . . . n on connecting portion 100. Control electrodes 156a, b, . . . n communicate signals between control circuit boards 152 in battery pack 20, and components of the hydraulic and control system 11 including controller 24, as will be described below. Tool frame 12 includes arms 166 forming slots 163 in tool frame 12 which are dimensioned and positioned to receive rails 161 extending from housing 159 of battery pack 20 allowing the battery pack 20 to be slid onto and off of tool frame 12.

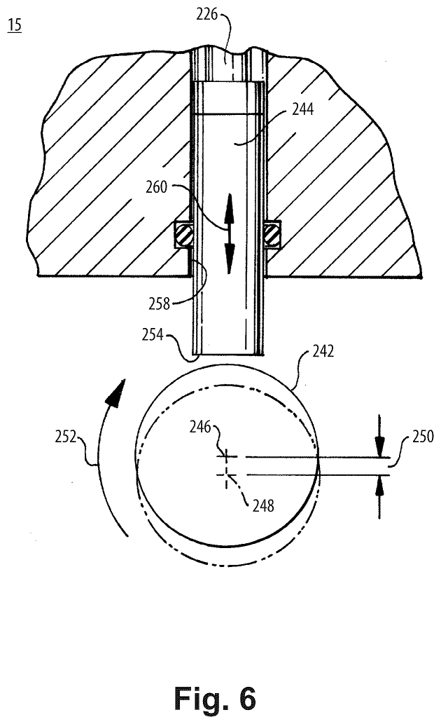

FIG. 6 shows components of pump 15 connected with gear reduction 48 arranged to drive hydraulic fluid to hydraulic drive 28 according to an embodiment of the disclosure. In an exemplary embodiment, pump 15 comprises the eccentric 242 and a pump piston 244. The eccentric 242 is connected to an output from the gear reduction 48. The eccentric 242 comprises a center 246 and a center axis of rotation 248. The center 246 is offset from the center axis of rotation 248 by an offset 250. Thus, as the eccentric 242 is rotated, as indicated by arrow 252, the eccentric moves between its solid line position and its dotted line position.

The pump piston 244 comprises a rear end 254 which is located against the outer surface of the eccentric 242. The eccentric 242 functions as a rotating cam. In the exemplary embodiment shown, the pump 15 comprises means (not shown) which biases the piston 244 against the eccentric 242, such as a spring or hydraulic pressure for example. The piston 244 is slidably located in a hole 258 of the frame 12. The piston 244 is adapted to slide back and forth in the hole 258 as indicated by arrow 260. The hole 258 is connected to the ram hydraulic drive conduit system 226. In the exemplary embodiment shown, the piston 244 has a diameter of about 0.312 in. However, in alternate embodiments, the piston 244 could have any suitable type of size or shape. For example, the piston 244 could have a diameter of between about 0.2-0.5 in. or perhaps even larger. In one type of preferred embodiment, the diameter is about 0.329-0.330 inch. In another type of preferred embodiment, the diameter is about 0.29 inch. Frame 12 may include a notch or groove 259 dimensioned and positioned to receive an O-ring 259 providing a seal around piston 244.

As the piston 244 moves in an outward direction in the hole 258, hydraulic fluid is sucked into the hole 258 from the fluid reservoir 22. As the piston 244 moves in an inward direction into the hole 258, hydraulic fluid in the hole 258 is pushed into the ram hydraulic drive conduit system 226. This hydraulic fluid subsequently pushes against the rear end of the piston 60 to move the piston forward. Movement of the piston 244 between its inner most position and its outer most position is equal to twice the offset 250. In an alternate embodiment, any suitable type of hydraulic pump 15 could be provided. For example, the pump could comprise a cam located against the rear end 254 of the piston 244 rather than an eccentric.

The tool 10 is preferably adapted to operate at a maximum hydraulic pressure of about 8,000-10,000 psi. However, in alternate embodiments, the tool could be adapted to operate at any suitable type of maximum hydraulic pressure, such as 6000 psi or 11,000 psi. With the system described above, the piston 60 is adapted to advance at a speed of about 0.007202 ft/sec (0.08643 in/sec) under no load conditions. According to one embodiment, the stroke of piston 60 from the retracted position, as shown in FIG. 3 to the fully extended position is about 2 inches.

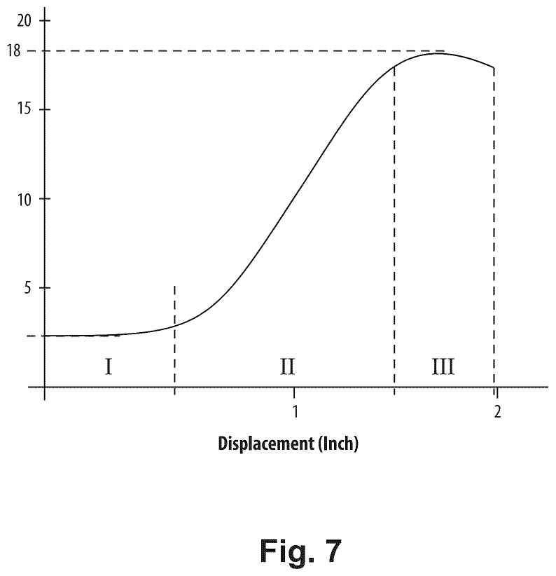

Electrical current supplied to motor 18 sufficient to generate a crimp varies as the crimp is created and as materials being crimped are deformed. Typically, motor 18 requires a peak current of about 18 amps when operating at a nominal voltage of 18 volts. This peak current must be delivered for a period of between about 1 and 60 seconds to create a typical crimp. The current required by the motor to drive pump 15 varies with the displacement of piston 60, as shown in FIG. 7.

According to one embodiment, the impactor 52 and anvil 54 may be configured and dimensioned so that when the piston 60 presses the impactor 52 into the anvil 54 they form a crimp connection having a desired shape. According to another embodiment, the impactor 52 and/or anvil 54 may include surface features that allow a die to be releasably connected to the impactor 52 and the anvil 54. By using a replaceable die, a variety of working surfaces can be provided on the tool to produce a variety of different shaped crimp connections.

When the motor 18 is activated the pressure in the hydraulic system increases, causing piston 60 to drive the impactor 52 toward the workpiece and the anvil 54. As shown in FIG. 7, current delivered to motor 18 from battery 20 prior to the impactor contacting the workpiece remains substantially constant, as shown in Region I in FIG. 7. Once the impactor 52 contacts the workpiece and presses the workpiece against the anvil 54, the workpiece begins to deform and the pressure in the hydraulic drive 28 rises steeply. This causes a rise in current delivered to motor 18 from battery 20, as shown in Region II of FIG. 7. As the impactor 52 compresses the workpiece in the final stage of forming the crimp, as shown in Region III of FIG. 7, current delivered by battery 20 reaches a maximum. When the pressure reaches a threshold pressure value P_{threshold}, the relief valve 29 opens causing the pressure in the hydraulic drive 28 to drop. When the pressure drops below a threshold minimum value P_{end} the controller 24 determines that the crimp cycle is complete. Controller 24 then activates light 25 to illuminate green if P_{threshold} was reached during the crimp cycle. If the pressure were to drop below P_{end} without having achieved P_{threshold} during the crimp cycle, the controller 24 would activate light 25 to illuminate red, indicating a potentially defective crimp connection. As a non-limiting example, the threshold minimum pressure P_{end} may be about 8,500 psi and the threshold pressure P_{threshold} may be about 9,000 psi. According to a further embodiment, instead of providing a mechanical relief valve 29, an electrically operated relief valve electrically connected to the controller 24 may be provided. According to this embodiment, the controller 24 monitors the pressure in the hydraulic drive 28 based on a signal from the pressure sensor 27 and opens the relief valve 29 when that pressure reaches the predetermined threshold value P_{threshold} ending the crimp cycle. As in the previous embodiment, if the pressure reaches P_{threshold} during the crimp cycle, the light 25 is illuminated green. If the predetermined threshold value P_{threshold} cannot be reached after a predetermined period of time, e.g., 5 seconds, the controller 24 will end the crimp cycle by turning power to the motor 18 off and the controller 24 would activate light 25 to illuminate red, indicating a potentially defective crimp connection.

According to yet another embodiment, a stroke sensor 16 (FIG. 2) may be provided. The stroke sensor 16 determines when piston 60 has reached the end of its range and/or that the working surfaces of the die are at their closest approach. When the die surfaces are at their closest approach, the space defined by the surfaces of the dies forms the desired shape of the finished crimp connection. The controller 24 monitors the stroke sensor 16 and when the piston 60 is at the end of its range, the controller 24 opens the relief valve 29 completing the crimp cycle. The controller 24 may also monitor the pressure sensor 27, and as with the previous embodiments, the light 25 is illuminated either green or red, depending on whether the threshold pressure P_{threshold} was reached during the crimp cycle.

According to a further embodiment, the force sensor 27 may be a load cell that monitors the force applied to the workpiece during the crimp cycle. The force measurement by the load cell 27 may be used by the controller 24 instead of (or possibly in addition to) the pressure monitored by a pressure sensor to determine whether sufficient maximum force is applied during a crimp cycle. The load cell 27 may be positioned between the impactor 52 and the anvil 54, or between the impactor 52 and its die.

In the illustrated embodiment of FIG. 2, the motor 18 is coupled to the controller 24 and battery pack 20. The controller 24, which is configured to control the motor 18, includes a printed circuit board, though other types of controllers may also be implemented. It will be appreciated that the motor 18 is adapted to operate at a nominal voltage corresponding to the voltage output by the battery pack 20. According to some embodiments, the battery pack generates a voltage of about 18V up to about 36V. For example, if the battery pack 20 outputs a voltage of about 24 volts, then the motor 18 would be adapted to operate at a nominal voltage of about 24 volts.

In the exemplary embodiment shown, the battery 20 is an 18 V DC battery. The motor 18 preferably comprises a RS-775WC-8514 motor manufactured by Mabuchi Motor Co., Ltd. of Chiba-ken, Japan. However, in alternate embodiments, any suitable type of motor adapted to operate above a 16 V nominal voltage could be used. For example, in one type of alternate embodiment, the motor might comprise a RS-775VC-8015 motor, also manufactured by Mabuchi Motor Co., Ltd., and which has a nominal operating voltage of about 16.8 volts. As another example, the motor might comprise a motor adapted to operate at a 24 V nominal voltage. The output shaft of the motor 18 is connected to the pump 16 by a gear reduction or gearbox 48. Any suitable type of gear reduction assembly could be provided.

The motor 18 is adapted to function with an operating voltage between 6-20 volts. Under a no-load condition, for example, in Region I shown in FIG. 7, such a motor 18 can operate at 19,500 rpm with a current of about 2.7 amps. At maximum efficiency, as the motor is at its highest load condition, for example, in Region III in FIG. 7, the motor 18 can operate at 17,040 rpm with a current of about 18.7 amps, a torque of about 153 mN-m (1560 g-cm), and an output of about 273 W.

In an illustrated embodiment, the battery pack 20 contains cells arranged to generate 18 V DC and thus the motor 18 is adapted to operate at that nominal voltage. It is envisioned that, at maximum efficiency, the motor 18 can operate at 17,040 rpm with a current of about 18.7 amps, a torque of about 153 mN-m (1560 g-cm), and an output of about 273 W.

Turning now to FIG. 5A, the battery pack 20 includes a housing 159. The housing 159 may be formed from a metal or polymer material. A plurality of rechargeable cells 150a, 150b, 150n, collectively 150 are provided within housing 159. According to one embodiment, cells 150 are connected in series so that the voltage provided by each cell adds to the total nominal voltage that can be delivered by battery pack 20. According to a further embodiment, some or all of cells 150 are connected in parallel, providing an increased maximum current deliverable by battery pack 20.

Contained within housing 20 is battery control circuit board 152. Circuit board 152 may include circuitry to monitor current, voltage, power output, charging current, and other electrical parameters of cells 150 and of battery pack 20 overall. According to a further embodiment, circuit board 152 monitors physical conditions of cells 150 and of pack 20 including temperature of each of cells 150a, 150b, . . . 150n, internal temperature of pack 20, number of charge/recharge cycles, external temperature, and the like. Power electrodes 154a, 154b are provided on a surface of pack 20. One or more control electrodes 156a, 156b, . . . 156n are also provided on a surface of pack 20. When battery pack 20 is connected with hydraulic tool 10, power electrodes 154a, 154b connect with circuitry in the tool via power contacts 162a, 162b to deliver current to motor 18. Control electrodes 156a, 156b, . . . 156n connect with corresponding electrodes 164a, 164b . . . 164n on tool 10 to interface control board 152 with controller 24.

Cells 150 are electrically connected by conductors 160 in a configuration that will generate a desired voltage output. For example, where cells 150 rely on lithium-ion chemistry, which generates about 3.7 volts, five cells may be connected in series to generate about 18.5 volts to drive motor 18 of hydraulic tool 10. According to one embodiment, one or more heat sinks 158 are connected with conductors 60 to dissipate heat generated by the cells during charging and discharging. Heat sinks 158 may include a high surface area portion 158a on the outer surface of battery pack 20. According to other embodiments, heat sinks may be shaped to provide passive convective cooling or may be equipped with heat pipes or an electrically driven fan (not shown) to facilitate removal of heat from cells 150.

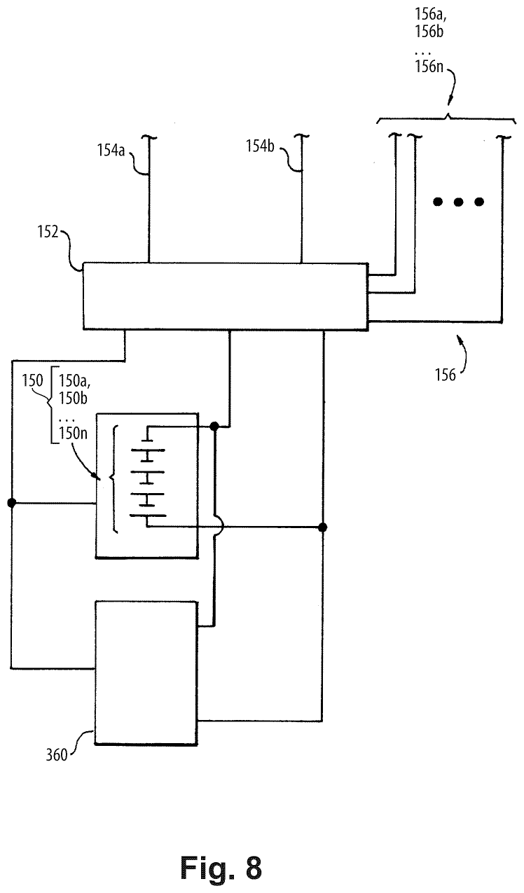

FIG. 8 is a block diagram illustrating an embodiment of electrical connections within battery pack 20. Cells 150a, 150b, . . . 150n are connected with circuit board 152. Circuit board 152 is connected with power electrodes 154a, 154b to deliver current to tool 10 and to receive current to recharge cells 150. Control bus 156 connects circuit board 152 with control electrodes 156a, 156b, . . . 156n on the surface of battery pack 20. The disclosure is not limited to a single circuit board 152 and includes embodiments where different functions are performed by one or more circuit boards and other electrical components, for example, power transistors, different locations within battery pack 20.

It is envisioned that the DC battery pack 20 has an amperage draw of at least 10 A to about 50 A and a voltage output of at least about 16V to about 36V. The rechargeable battery of the present disclosure is contemplated to utilize solid-state and non-solid state battery technology, as will be described in more detail below.

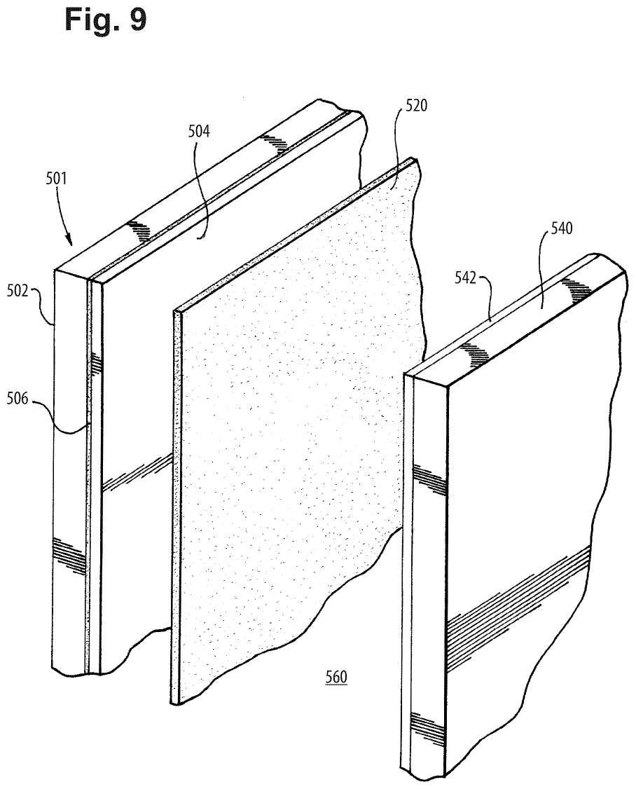

According to one embodiment, each of cells 150 include two conductive electrodes in contact with an electrolyte solution. FIG. 9 shows a portion of one of cells 150. According to one embodiment, first electrode 501 includes a conductive substrate 502, which may be a metal foil, such as an aluminum or copper foil. One or more layers 504, 506 are formed on the surface of the substrate. An outermost layer 504 includes a reactive species. The reactive species includes, but is not limited to, a metal oxide, for example lithium oxide, vanadium oxide, and the like. A support layer 506 may be provided between the reactive species 504 and the substrate 502. According to one embodiment, support layer 506 includes a carbon allotrope, such as graphene, or is formed from one or more three-dimensional carbon allotropes such as graphene nanotubes, fullerenes, carbon fiber-cloth, carbide-derived carbon, and/or a carbon aerogel. According to a preferred embodiment, support layer 506 is formed from graphene sheets or flakes of graphene bonded with substrate 502. The reactive species layer 504 is bonded to the graphene surface using a liquid-phase or gas-phase reaction, chemical vapor deposition, physical vapor deposition, plasma deposition, or other techniques known in the field of the disclosure.

A separator membrane 520 is provided proximate to the surface of first electrode 501. Second electrode 540 is provided proximate membrane 520 opposite from first electrode 501. An electrolyte is provided in the space 560 between first electrode and second electrode 540. The membrane 520 is permeable to ions dissolved in the electrolyte to allow the ions to flow through space 560 between the electrodes during charging and discharging. According to one embodiment, second electrode 540 is formed by lithium metal atoms dispersed within the crystal structure and/or pores of graphite. Alternatively, second electrode 540 comprises one or more carbon allotropes. A lithium salt (typically a fluoride or phosphide salt) dissolved in an organic solvent forms the electrolyte in space 560.

When cell 150 is discharged, for example, to power tool 10, lithium atoms adsorbed on the second electrode 540 are oxidized, generating positively charged lithium ions and liberating electrons to create current to drive the tool. The positively charged lithium ions dissolve in the electrolyte, diffuse through membrane 520, and migrate to the negatively charged first electrode 501, where they reduce the charge state of reactive species layer 504.

During charging the reactions are reversed. Positively charged lithium ions are liberated from reactive species layer 504 on first electrode 501 and diffuse through the electrolyte to the second electrode 540. At the second electrode 540, these ions combine with electrons to reduce the lithium ions to neutral lithium atoms that are incorporated into the second electrode 540.

The electrolyte solution allows ions to move between the electrodes. Separator 520, such as a porous polymer membrane, creates an electrically insulating barrier between the electrodes preventing electrical short circuits, while also allowing the transport of ionic charge carriers that are needed to close the circuit during the passage of current. According to some embodiments, the material forming the separator 520 is selected to provide safety properties, such as having a melting point and flow characteristics that halt the flow of ions if the temperature of the cell exceeds a selected threshold, thus shutting off the cell before dangerous overheating can occur. Chemical reactions at the electrodes deliver current from battery pack 20 to hydraulic tool 10. According to one embodiment, cells 150 use lithium-ion chemistry to store and deliver current to hydraulic tool 10. According to a further embodiment, one or both of the electrodes of cells 150 incorporate a carbon allotrope, such as graphene, to react with, to adsorb, and to desorb moieties generated by the oxidation-reduction reactions during charging and discharging.

According to one embodiment, layers 506 and/or 542 incorporate graphene particles, flakes, or sheets. According to another embodiment, layer 506 and/or layer 542 are formed from a composite material, incorporating graphene or other carbon allotrope with a metal such as copper. A hybrid graphene/metal material may reduce the cost of the electrode while providing a sufficient amount of the carbon allotrope on the surface of the electrode to support the desired electrochemical reactions.

It is believed that by distributing reactive species, at the first or second electrode 501, 540 onto the two-dimensional surfaces of graphene an improved distribution of those species is achieved as compared with intercalating the reactive species into the pore structure of graphite in known lithium-ion cells. Ideally, a monolayer of reactive species is bonded to the graphene surfaces, maximizing the portion of the reactive species available to particulate in the redox reactions during charging and discharging. According to other embodiments, a portion of the graphene surface has a monolayer of the reactive species bonded to it.

Graphene has a very high electrical and thermal conductivity. Metal oxides used as reactive species, such as CoO₂ are generally poor conductors of heat and of electricity. Graphene provides a low electrical resistance path, reducing resistive losses within the cells, and reducing the amount of resistive heating. Resistive heating is especially problematic in hydraulic tools, for example, crimping tools, because these tools may require large amount of current for brief periods of time while the crimp is being formed. Resistive heating increases with increasing current drawn from the cell. For high current uses, such as hydraulic tools, low resistance graphene materials reduce heating, leading to better performance and longer battery life. Because graphene has a low thermal resistance, heat generated during redox reactions flows rapidly into the metal substrate of the electrodes and can be dissipated by providing a heatsink 158, as shown in FIG. 5A.

It is further envisioned that carbon allotropes, such as graphene, may also be incorporated in second electrode 540, such as for example by utilizing a copper-supported graphene nanoflakes electrode. According to another embodiment, instead of providing a surface layer incorporating graphene, all, or a major portion of both electrodes are formed to include graphene by providing a functionalized graphene cathode and a reduced graphene oxide anode.

According to one embodiment, one or both electrodes 501, 540 are formed as a composite material including a metal or metallic material integrated or incorporated with graphene. Optionally, graphene is used as a support material/structure for the solid-state metallic electrode. Alternatively, the composite material of the electrode may be formed by incorporating other species into the graphene-lithium-ion electrodes such as sulfur and sulfur compounds.

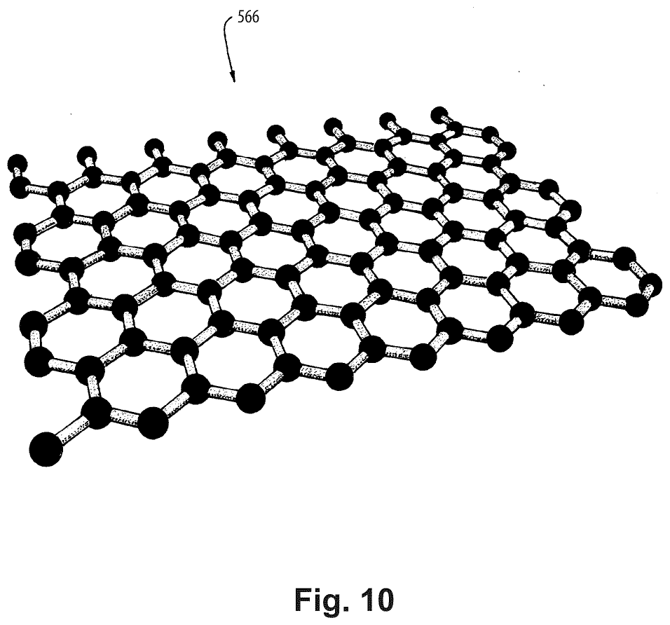

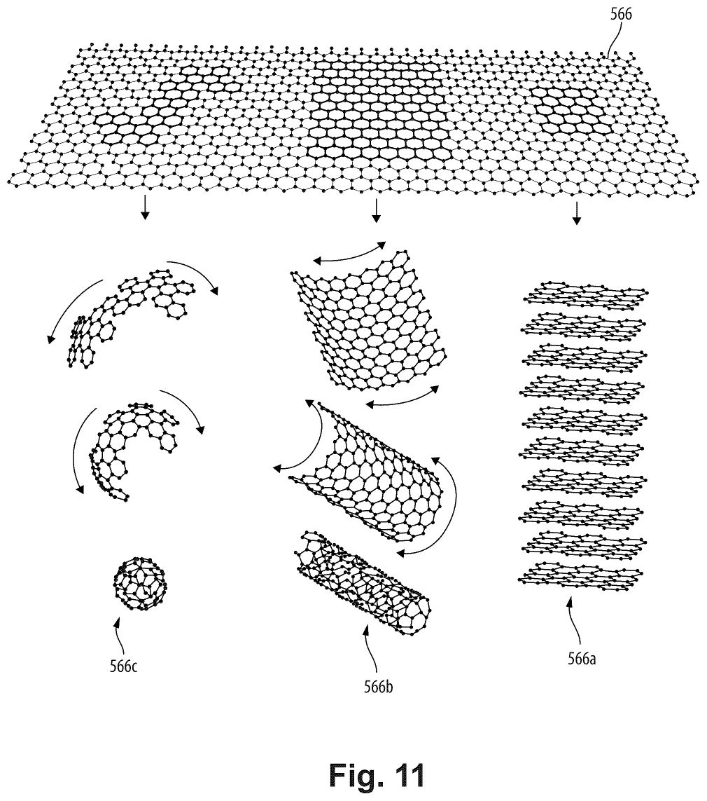

As shown in FIGS. 10 and 11, graphene is a composition of carbon atoms tightly bound in a hexagonal structure 566, which structure is just one atomic layer thick, essentially making a graphene sheet two-dimensional. One benefit of the two-dimensional graphene sheet is its large theoretical specific surface area (SSA) of approximately 2,630 square meters per gram (m²/g). Such ratio of surface area per gram of substance is particularly important for battery components, as it allows them to store and release charge carriers. The more charge carriers (like Li-ions) the material can store and release, the greater the storage and rate of energy transfer. Additionally, the two-dimensional graphene lattice sheet offers high mechanical strength, light weight, and flexibility. According to other embodiments, graphene materials with somewhat less than a theoretical maximum specific surface area may be used within the scope of the disclosure. According to one embodiment, graphene materials comprising one or more of electrodes 501, 540 has a surface area greater than about 500 m²/g, preferably greater than 800 m²/g, more preferably greater than about 1000 m²/g.

Instead of, or in addition to electrode surfaces including graphene sheets, other carbon allotropes formed into three-dimensional shapes may be provided. As shown in FIG. 11, a graphene lattice of tightly bound carbon atoms 566 may be formed into flakes 566a. Carbon allotropes may be formed into higher dimensional shapes (sometimes called fullerenes). These shapes may include tubes 566b, sometimes referred to as nanotubes. According to other embodiments, such carbon allotropes may be formed into spheres 566c, sometimes referred to as bucky balls or other three-dimensional shapes. According to a further embodiment, combinations of sheets, flakes, and fullerenes may be provided to form support layer 506.

These graphene flakes, tubes, and balls are conductive, highly porous, and readily bond with lithium ions (i.e., are lithophilic). According to some embodiments, these carbon allotropes facilitate a more uniform distribution of reactive species that previously known electrode materials, for example, reactive species intercalated in pores of a graphite substrate. The carbon allotrope surfaces have a high scalable surface area that can potentially support greater numbers of active moieties in contact with the electrolyte. Also, because these sheets, flakes, tubes, and balls are highly porous, they may allow lithium ions and atoms to migrate through the bulk of the support layer 506, increasing the number of species available to react during charging and discharging of cell 20.

Cells 50 forming battery pack 20 may include carbon allotrope materials to form one or both electrodes 501, 540. In addition to carbon allotrope materials, other conductive species that provide a large surface area and are lithophilic may be used. For example, support layer 506 may include nanowires formed, for example, using silicon, germanium and/or transition metal oxides, such as Cr₂O₃, Fe₂O₃, MnO₂, Co₃O₄ and PbO₂.

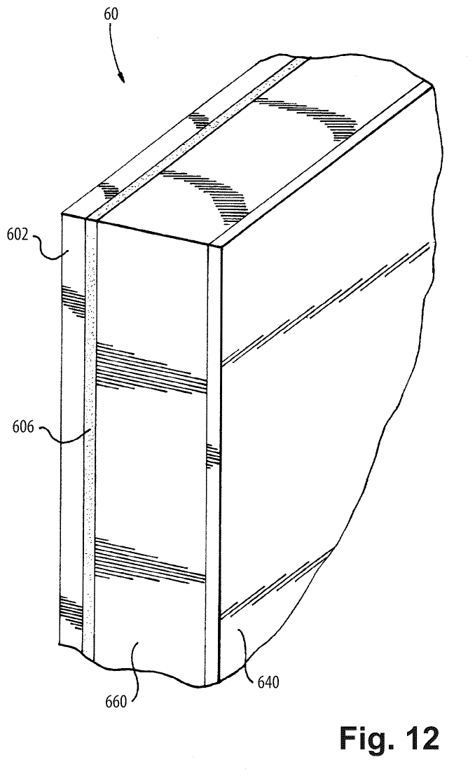

According to yet another embodiment, the battery pack 20 may include one or more cells 50 that capacitively store electrical charge. Such cells are sometimes referred to as supercapacitors or ultracapacitors. FIG. 12 is a schematic of a portion of an ultracapacitor cell 60 that may be substituted for one or more of the cells 50 in the embodiment of FIG. 5A. Negative electrode 602 and positive terminal 640 are separated by a liquid or semiliquid electrolyte 660. An insulating, dielectric layer 606 is formed on the surface of electrode 602. This layer may be an oxide or other compound of the material forming positive electrode 602. Electrolyte 660 is in contact with layer 606 and forms the negative electrode of the cell. Negative terminal 640 is in contact with the electrolyte 660. During charging, electrons are delivered to negative terminal 640. Cations within electrolyte 660 migrate toward layer 606 the surface of layer. Positive charges within electrode 602 accumulate on the opposite side of layer 606. An electric field is formed across dielectric layer 660 that orients moieties within the dielectric to effectively reduce the field imposed by electrodes 602, 640 thereby increasing the capacity of the capacitor to hold the charge. During discharging, for example, when current is drawn from battery pack 20 to operate tool 10, electrons flow from negative terminal 640 through the load, such as motor 18, and onto positive electrode 602.

This internal cell structure allows the ultracapacitor cell to have a very high energy storage density. In general, ultracapacitors store less energy than a similarly sized battery, however, they can release their energy much more rapidly, as the discharge is not dependent on a chemical reaction taking place. Ultracapacitors can be recharged a large number of times with little or no degradation. The material used for positive electrode 602 and negative terminal 640 in the ultracapacitor cell may be a carbon material, such as graphite or a carbon compound such as a carbide. Such materials may be formed as carbon fiber-cloth or a carbon aerogel. Alternatively, or in addition, electrode 602 and/or terminal 640 may comprise one or more of the carbon allotrope materials discussed in the previous embodiments, such as graphene sheets, flakes, nanotubes, and nanoballs.

By including ultracapacitor cells 60 as one or more of the cells 150 of battery pack 20, such as the one shown in FIG. 5A, tools 10 according to embodiments of the disclosure are capable of delivering bursts of energy during peak periods of power demand. Ultracapacitor cells 60 are capable of charging very rapidly, allowing batter pack 20 to be recharged in a short period of time as compared with electrochemical cells. These features allow hydraulic tool 10 to be charged rapidly. Additionally, an ultracapacitor cell may weigh less than an electrochemical cell battery, reducing the weight of tool 10 compared with known tools. In addition, the materials used to form ultracapacitor cells 60 may be less toxic and more easily biodegraded than materials used to form electrochemical cells. According to another embodiment, it is envisioned that the battery pack 20 may include a combination of one or more ultracapacitors and one or more electrochemical cells. These electrochemical cells may use known battery technology (i.e., conventional Li-ion cells) or may be cells formed using carbon allotrope materials, as discussed with regard to other embodiments of the disclosure.

In further alternative embodiments described below, it is envisioned that the battery pack 20 may include cells 150 that utilize other chemically reactive species. For example, battery pack 20 may include one or more rechargeable lithium-sulfur (Li—S) cells, which provide for high specific energy (energy per unit mass) and higher energy density when compared to conventional Li-ion cells. The Li—S cells are relatively light due to the low atomic weight of lithium and moderate atomic weight of sulfur. Additionally, sulfur is an inexpensive and relatively non-toxic material. According to some embodiments, cells 150 formed using a sulfur cathode have a theoretical charging capacity of about 1,675 milliampere-hours/gram (mAh/g).

One or more cells 150 of battery pack 20 may be nickel-hydrogen (Ni—H₂) cells. According to one embodiment, N—H₂ cells use gaseous hydrogen as the negative electrode and nickel metal as the positive electrode. Although the energy density of a Ni—H₂ cell may be significantly lower than that of conventional Li-ion cell, Ni—H₂ cells have almost perfect faradic efficiency and very high numbers of charge/discharge cycles.

Cells 150 according to a further embodiment include rechargeable aluminum-ion (Al-ion) cells. An Al-ion cell includes two electrodes separated by a space filled with a liquid or semiliquid electrolyte. Aluminum ions flow between the electrodes through the electrolyte and react with active species on the electrodes to store charge and to discharge to power tool 10. Because aluminum ions can have a trivalent charge state Al³⁺, Al-ion cells may have a higher charge density than cells that rely on lithium, which has a monovalent charge state (Li⁺). Aluminum ions thus transfer three units of charge by one ion, which significantly increases the energy storage capacity of the battery. Other advantages of aluminum over lithium include higher energy density potential, lower material costs and low flammability if the battery is short-circuited.

According to a further embodiment, one or more of cells 150a, 150b, . . . 150n use different energy storage technologies. According to one embodiment, one or more of cells are ultracapacitors, while others of the cells 150a, 150b, . . . 150n rely on chemical reactions to store electrical energy. As shown in FIG. 8, one or more ultracapacitors 360 are connected with cells 150a, 150b, . . . 150n and with circuit board 152. According to one embodiment, circuit board 152 draws current from cells 150, such as lithium-ion cells 150 and uses that current to charge ultracapacitor 360 while tool 10 is idle. When tool is actuated to form a crimp, circuit board 152 draws current from one or more of the ultracapacitors 360 and cells 150. Because ultracapacitor 360 is able to deliver greater current than electrochemical cells 150, the current output of the battery pack 20 is increased, relative to a battery pack 20 using only electrochemical cells.

As shown in FIG. 2, tool 10 includes motor 18 that mechanically drives hydraulic pump 15 via gear reduction 48. FIG. 6 shows such a pump according to embodiments of the disclosure. FIG. 7 shows a graph of current delivered by battery 20 to motor 18 during a crimping operation according to an embodiment of the disclosure.

In operation, workpiece 115 is placed between the ram 105 and the anvil 110, shown in FIGS. 1, 3, and 4. The tool is actuated by pressing trigger 42, causing motor to be energized by current from battery pack 20. At the beginning of the operation, ram 105 may be separated from the surface of workpiece 115. At this stage, ram 105 moves freely toward anvil and no deformation of the workpiece has occurred. As shown in Region I of FIG. 7, motor 18 draws a minimum current from battery 20 while ram 105 is moved toward the workpiece. Accordingly, motor 18 is required to generate a minimum torque. According to some embodiments, motor operates at 19,500 rpm with a current of about 2.7 amps.

When ram 105 contacts the workpiece 115 and begins to deform it, the pressure within hydraulic drive 28 rises, increasing the mechanical resistance on piston 60 to displacement by motor shaft 42. Torque generated by motor 18 increases as the force required to continue deforming workpiece 115 increases. As a result, current delivered by battery 20 increases and the speed of the motor rotation decreases, as shown in Region II of FIG. 7.

As ram 105 nears the end of its travel continued deformation of workpiece 115 requires additional force, as shown in Region III of FIG. 7. According to one embodiment, motor 18 operates at 17,040 rpm with a current of about 18.7 amps, a torque of about 153 mN-m (1560 g-cm), and an output of about 273 W at the point where the work required to deform the workpiece is at its maximum.

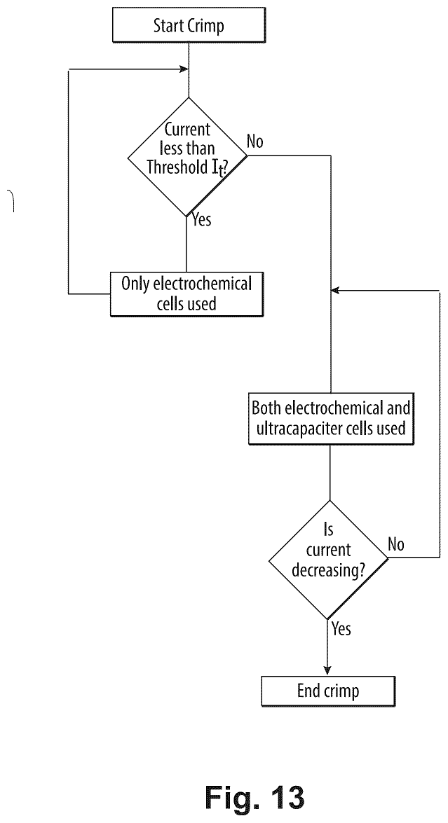

According to one embodiment of the disclosure, battery 20 is comprised of a combination of electrochemical cells 150 and ultracapacitors 360, as shown in FIG. 8. Circuit board 152 includes sensor and logic circuits suitable for implementing the process illustrated in the flowchart of FIG. 13. At the beginning of the crimp in Region I, relatively little current is required to move ram 110 before it contacts the workpiece. According to one embodiment, circuit 152 includes a current threshold It. While current drawn by tool 10 is below It circuit 152 draws current only from electrochemical cells 150a, 150b, . . . 150n. Once ram 110 contacts workpiece 115, motor torque and hence current draw increases, as shown in Region II of FIG. 7. As shown in FIG. 13, circuit 152 detects current exceeding threshold Iₜ. To deliver increased current, circuit 152 draws current from both the electrochemical cells 150a, 150b, . . . 150n and from ultracapacitors 360. Because ultracapacitors can deliver very high current, the increased current available in Region II and in Region III where a maximum current is required, this embodiment may allow fewer or smaller electrochemical cells to form battery 20. Once the workpiece is fully deformed, for example, once valve 29 opens, current flowing from battery 20 drops. This current drop is sensed by circuit 152, which disconnects the ultracapacitor 360 from tool 10. According to one embodiment, once the crimp is complete, circuit 152 draws current from electrochemical cells 150a, 150b, . . . 150n to recharge ultracapacitor 360 to ready the tool for a subsequent crimp. Because ultracapacitor 360 can be charged quickly, the time required for battery 20 to be ready for the next crimp may be short.

As it should be apparent from the description above, and due to the recent technological advances in battery technology that provide significant performance benefits if employed in a battery powered tool, the battery powered hydraulic crimp tool 10 is configured to operate more efficiently, to have lower weight, and to have a longer battery lifetime compared with known tools. These performance benefits include but are not limited to reduced crimp cycle time, higher torque for a given current, and higher efficiencies. Alternatively, the battery powered hydraulic crimp tool 10 is configured to operate at lower voltages than the industry standard but provide for much longer energy charge, lighter weight and/or charge cycles.

Changes and modifications in the specifically described embodiments may be carried out without departing from the principles of the present invention, which is intended to be limited only by the scope of the appended claims, as interpreted according to the principles of patent law including the doctrine of equivalents.

What is claimed is:

1. A hand-held battery powered hydraulic tool comprising:
a tool frame having a motor;
a working head operatively coupled to the tool frame and selectively actuatable by the motor; and
a rechargeable battery pack configured to power the motor, the battery pack is removably connected to the tool frame, wherein the battery pack comprises one or more cells, wherein the cell comprises
first and second electrodes; and
an electrolyte,
wherein one or both of the first and second electrodes comprise a support layer and an electrochemically reactive species on the support layer and in contact with the electrolyte, and wherein the support layer comprises a high specific surface area material.

2. The hand-held battery powered hydraulic tool of claim 1, wherein the high specific surface area material is a carbon allotrope.

3. The hand-held battery powered hydraulic tool according to claim 2, wherein the carbon allotrope is selected from one or more of graphene sheets, graphene flakes, graphene nanotubes, and graphene spheres, carbon fiber-cloth, carbide-derived carbon, and/or a carbon aerogel.

4. The hand-held battery powered hydraulic tool according to claim 2, wherein allotrope is integrated with a solid-state metallic material.

5. The hand-held battery powered hydraulic tool according to claim 2, wherein both the first and second electrodes each comprise the support layer comprised of the allotrope.

6. The hand-held battery powered hydraulic tool of claim 1, wherein the battery comprises a control circuit connected with the cell, wherein the control circuit monitors one or more parameters of the cell and controls the flow of current through the cell.

7. The hand-held battery powered hydraulic tool of claim 1, wherein the cell does not comprise cobalt or a cobalt containing compound.

8. The hand-held battery powered hydraulic tool of claim 1, wherein the cell includes reactive species dissolved in the electrolyte, wherein the reactive species undergo electrochemical reactions on the first and second electrodes.

9. The hand-held battery powered hydraulic tool of claim 8, wherein the reactive species include one or more metals selected from lithium, potassium, sodium, magnesium, sulfur, aluminum, nickel, and vanadium and oxides thereof.

10. The hand-held battery powered hydraulic tool of claim 9, wherein the reactive species forms a monolayer across at least a portion of the surface of the support layer.

11. The hand-held battery powered hydraulic tool of claim 1, wherein the tool is a drill, a saw, a grinder, a crimping tool, or a fastener gun.

12. The hand-held battery powered hydraulic tool of claim 1, wherein the cell uses a lithium-ion technology to store and deliver electrical energy.

13. The hand-held battery powered hydraulic tool of claim 1, wherein one of the first and second electrodes comprises sulfur or a compound of sulfur and another of the first and second electrodes comprises lithium or a compound of lithium.

14. The hand-held battery powered hydraulic tool of claim 1, wherein one of the first and second electrodes comprises nickel or a compound of nickel and another of the first and second electrodes comprises hydrogen and wherein the cell further comprises a catalyst.

15. The hand-held battery powered hydraulic tool of claim 1, wherein the battery further comprises a capacitive electrical storage device.

16. The hand-held battery powered hydraulic tool of claim 1, wherein the one or more cells comprise a plurality of cells, wherein the plurality of cells are electrically connected in series to generate an output voltage of about 16 volts to about 24 volts.

17. The hand-held battery powered hydraulic tool of claim 1, wherein the cell further comprises a membrane disposed between the first and second electrodes and wherein ions generated by the electrochemically reactive species diffuse through the membrane.

18. The hand-held battery powered hydraulic tool of claim 17, wherein the membrane comprises a melting point and flow characteristics such that, when a temperature of the electrolyte exceeds a threshold temperature, the membrane prevents the ions from diffusing through the membrane.

19. The hand-held battery powered hydraulic tool of claim 2, wherein the carbon allotrope comprises graphene with a specific surface area of about 2630 square meters per gram.

20. The hand-held battery powered hydraulic tool of claim 1, wherein the high specific surface area material comprises nanowires formed from one or more of silicon, germanium, and a transition metal oxide.

21. A battery powered crimping tool comprising:
a tool frame having an electrical motor;
a hydraulic pump mechanically connected with the motor;
a piston hydraulically connected with the pump to move relative to the tool frame, wherein the piston comprises a ram;
an anvil mechanically fixed to the tool frame, wherein movement of the piston drives the ram toward the anvil, wherein the ram and anvil are adapted to deform a workpiece placed between the anvil and the ram;
a battery electrically connected with the motor, wherein the battery comprises one or more rechargeable electrochemical cells and one or more capacitive storage devices;
a controller electrically connected with the cell and storage device of the battery and with the motor,
wherein, at first phase of a crimp, the controller disables current from flowing from the capacitive storage device and allows current to flow from the electrochemical cell to energize the motor to cause the hydraulic pump to move the piston to contact the workpiece with both the anvil and the ram,
wherein, at a second phase of a crimp, motion of the ram deforms the workpiece and the controller allows current to flow from both the capacitive storage device and the electrochemical cell to energize the motor to enable the further motion, and,
wherein, at a third phase of the crimp, the controller detects that the crimp is completed and disables current from flowing from both the capacitive storage device and the electrochemical cell.

22. The tool of claim 21, wherein, following the third stage of the crimp, the controller allows current to flow from the electrochemical cell to the capacitive storage device to recharge the capacitive storage device.

23. A battery for powering a hand tool, the battery comprising:
one or more rechargeable electrochemical cells;
one or more capacitive storage devices; and
a controller electrically connected with the cell and storage device and the tool,
wherein, at first phase of operation of the tool, the controller disables current from flowing from the capacitive storage device and allows current to flow from the electrochemical cell to energize the tool,
wherein, at a second phase of operation of the tool, the controller allows current to flow from both the capacitive storage device and the electrochemical cell to energize the tool, and,
wherein, at a third phase of operation of the tool, the controller disables current from flowing from both the capacitive storage device and the electrochemical cell.

24. The battery of claim 21, wherein, following the third phase, the controller allows current to flow from the electrochemical cell to the capacitive storage device to recharge the capacitive storage device.
